(19) United States
(12) Patent Application Publication
(10) Pub. No.: US 2002/0174113 A1
(43) Pub. Date: Nov. 21, 2002

(54) Document retrieval method /device and storage medium storing document retrieval program

(76) Inventors: Homare Kanie, Yokohama (JP); Mikihiko Tokunaga, Fujisawa (JP); Hitoshi Tanaka, Yokohama (JP)

Correspondence Address: MCDERMOTT, WILL & EMERY, 600 13th Street, N.W., Washington, DC, 20005-3096, US

(21) Appl. No.: 10/034,991

(22) Filed: Jan. 3, 2002

(30) Foreign Application Priority Data
Jan. 10, 2001 (JP) 2001-002810

(51) Int. Cl. G06F 17/30

(52) U.S. Cl. 707/3

(57) ABSTRACT

The efficiency of document retrieval work is improved by retrieving suitable related words conforming to the user's intention. The document retrieval method for retrieving desired documents from a document database by using a key word includes: extracting related words relating to an input key word and terms of validity of the related words; retrieving documents by using the extracted related words as retrieval words; and selecting documents that satisfy the extracted terms of validity from among the retrieved documents.

### BACKGROUND OF THE INVENTION

The present invention relates to a document retrieval device for retrieving desired documents from documents stored in a document database, by using a key word. In particular, the present invention relates to a technique that is effective when applied to a document retrieval device for retrieving a key word and related words relating to the key word.

As processing for retrieving desired documents from a document database in which a large amount of documents have been registered, there is full text retrieval. This is retrieval of detecting documents having a key word specified by the user therein as desired documents. In this retrieval, the user can specify an arbitrary key word. However, there is a problem there are retrieval omissions as to documents in which the key word is represented by its related word or its different expression. In order to dissolve this problem, there is a technique in which retrieval is conducted by using words relating to the key word, such as precise equivalents or synonyms for the key word, as retrieval words and thereby retrieval omissions are reduced. If related words of the key word are also retrieved, retrieval omissions are reduced. However, in some cases, documents different from user's purpose are retrieved. It becomes a problem that the conformity between documents desired by the user and retrieved documents declines.

In order to solve such a problem, it has been proposed to set degrees of association for related words of the key word, retrieve basised on the key word and the degree of association fed by the user, and then prevent to obtain unnecessary retrieval results. For example, JP-A-9-44506 describes a document retrieval device capable of obtaining suitable words related to the user's intention and retrieving the document more efficiently. In summary, association degree conditions, such as a range of association degree of developed related word group, are input by association degree condition input means. If the association degree which indicates the degree of association between related words satisfies the association degree condition specified by the association degree condition input means, then words belonging to that related word group are used in retrieval as retrieval words.

### SUMMARY OF THE INVENTION

In the above conventional technique of document retrieval device, the intensity of relation to the key word does not change with time elapse, but it is fixed. In the case where retrieval is conducted for such a key word that synonyms and related words change with time, therefore, desired documents are not retrieved in some cases from a database stored over a long period of time. If a plurality of related words have been registered for a key word with time, undesirous documents are included in the retrieval result.

An object of the present invention is to provide a technique to solve the above problems and by retrieving suitable related words conforming to the user's intention, to improve document retrieval work efficiency.

Another object of the present invention is to provide a technique to increase the speed to retrieve related words within the term of validity.

Still another object of the present invention is to provide a technique to enable to perform an expansion to such a configuration as to retrieve related words within the term of validity without remarkably altering an existing system.

In accordance with an aspect of the present invention, a document retrieval device for retrieving desired documents from a document database by using a key word retrieves the related words relating to a key word with respect to documents that include the related words and that satisfy the terms of validity.

In accordance with another aspect of the present invention, related words relating to a key word and terms of validity of the related words are held in a time serial related word dictionary beforehand. When a user who is going to retrieve documents inputs a key word, related words relating to the key word and terms of validity of the related words are extracted from the time serial related word dictionary. Documents are retrieved by using the extracted related words as retrieval words. Thereafter, documents within the extracted terms of validity are selected from the retrieved documents, and held as a retrieval result of the related words relating to the input key word.

Thus, in the present invention, when retrieving documents by using a key word for which synonyms and related words change with time elapse, documents that contain related words, such as precise equivalents or synonyms, developed from the key word and that satisfy the terms of validity are retrieved, besides retrieval using the key word itself. The documents thus retrieved are obtained as retrieval results of the related words. Therefore, retrieval of suitable related words that meets the time elapse can be conducted. In addition, omissions of documents desired by the user and noise can be reduced.

In the document retrieval device of the present invention, retrieval of the related words relating to a key word is conducted with respect to documents that include the related words and that satisfy the terms of validity, as heretofore described. Therefore, it is possible to retrieve suitable related words that meet the user's intention and improve the efficiency of the document retrieval work.

### BRIEF DESCRIPTION OF THE DRAWINGS

FIG. 1 is a diagram showing a schematic configuration of a document retrieval device.

FIG. 2 is a flowchart showing a processing procedure of retrieval processing.

FIG. 3 is a diagram showing a concrete example of retrieval processing.

FIG. 4 is a diagram showing a schematic configuration of a document retrieval device.

FIG. 5 is a flowchart showing a processing procedure of retrieval processing.

FIG. 6 is a diagram showing a concrete example of retrieval processing.

FIG. 7 is a diagram showing a schematic configuration of a document retrieval device.

FIG. 8 is a flowchart showing a processing procedure of retrieval processing.

FIG. 9 is a diagram showing a concrete example of retrieval processing.

### DESCRIPTION OF THE EMBODIMENTS

Hereafter, there will be described a document retrieval device that extracts related words relating to a key word and terms of validity of the related words from a time serial related word dictionary and selects documents of related words within terms of validity on the basis of a result of retrieval using he related words as retrieval words.

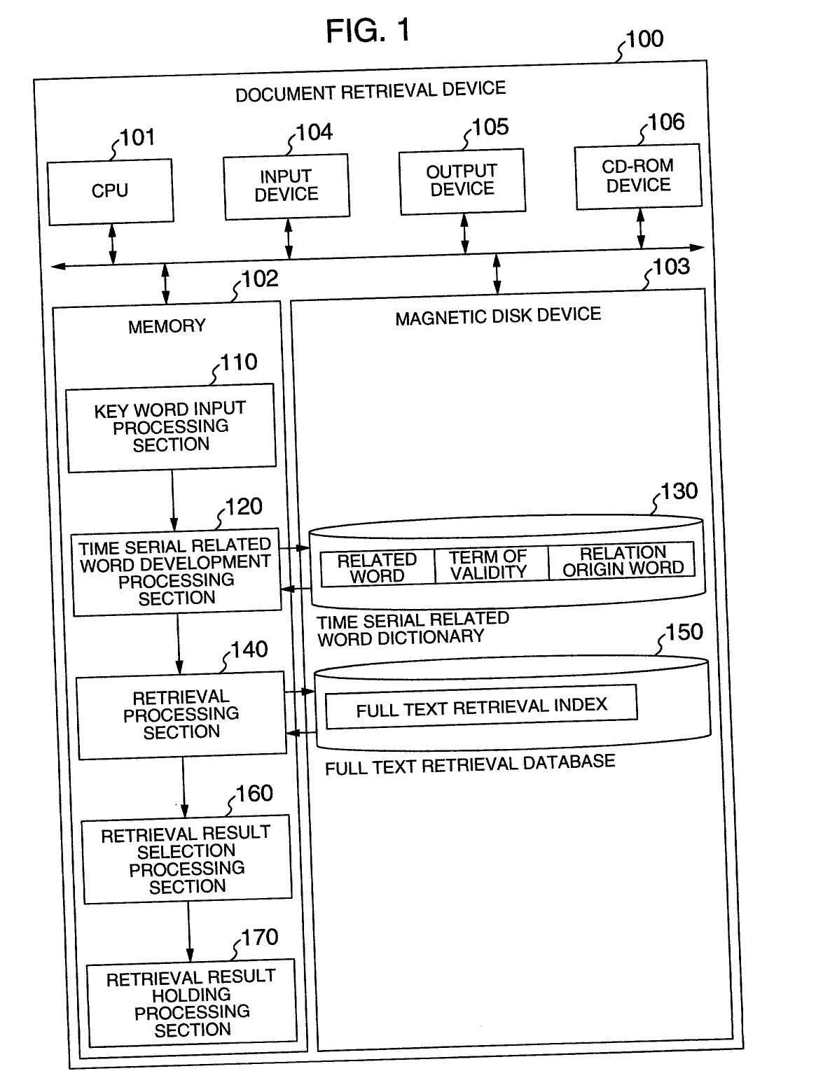

FIG. 1 is a diagram showing a schematic configuration of a document retrieval device 100 of an embodiment. The document retrieval device 100 shown in FIG. 1 includes a CPU 101, a memory 102, a magnetic disk device 103, an input device 104, an output device 105, a CD-ROM device 106, a time serial related word dictionary 130, and a full text retrieval database 150.

The CPU 101 is a device that controls operation of the whole of the document retrieval device 100. The memory 102 is a device for loading various processing programs and data when controlling the operation of the whole of the document retrieval device 100.

The magnetic disk device 103 is a device for storing the various processing programs and data. The input device 104 is a device for conducting various kinds of inputting in order to retrieve documents that contain related words relating to the key word and that are within terms of validity of the related words.

The output device 105 is a device for conducting various kinds of outputting, which accompany the document retrieval. The CD-ROM device 106 is a device for reading out contents of a CD-ROM having various processing programs recorded thereon. The time serial related word dictionary 130 is a dictionary that holds related words for an arbitrary key word and terms of validity of the related words. The time serial related word dictionary 130 holds data by handling a related word, a term of validity, and a relation origin word as one set. The full text retrieval database 150 is a database that holds documents containing an arbitrary key word or its related words, and full text retrieval indexes for retrieving the documents.

The document retrieval device 100 further includes a key word input processing section 110, a time serial related word development processing section 120, a retrieval processing section 140, a retrieval result selection processing section 160, and a retrieval result holding processing section 170.

The key word input processing section 110 is a processing section that receives a key word for retrieval and a retrieval request from the outside such as an application. The time serial related word development processing section 120 is a processing section for extracting related words relating to a key word, which is input by the key word input processing section 110, and terms of validity of the related words from the time serial related word dictionary 130.

The retrieval processing section 140 is a processing section for retrieving documents stored in the full text retrieval database 150, by using the extracted related words as retrieval words. The retrieval result selection processing section 160 is a processing section for collating creation dates of the documents retrieved by the retrieval processing section 140 with the terms of validity of the related words, and selecting documents within the extracted terms of validity from the retrieved documents. The retrieval result holding processing section 170 is a processing section for holding the documents obtained by the selection conducted in the retrieval result selection processing section 160, as a retrieval result.

A program for making the document retrieval device 100 function as the key word input processing section 110, the time serial related word development processing section 120, the retrieval processing section 140, the retrieval result selection processing section 160, and the retrieval result holding processing section 170 is recorded on a storage medium such as a CD-ROM, stored on a magnetic disk or the like, and thereafter loaded into a memory and executed. The storage medium for recording the program thereon may also be a storage medium other than the CD-ROM.

Although retrieval conducted by using related words relating to a key word as retrieval words will be described, retrieval using the key word as a retrieval word is conducted separately. This holds true in other cases as well.

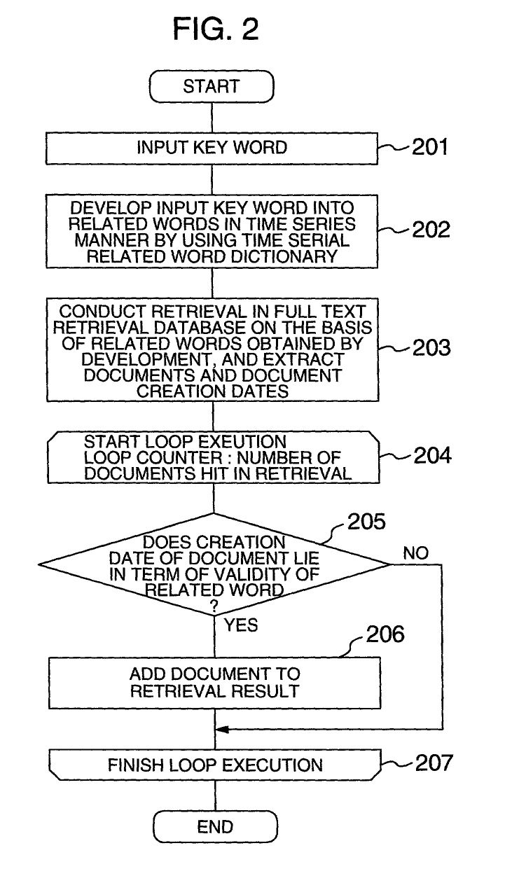

FIG. 2 is a flowchart showing a processing procedure of retrieval processing. Processing of the device of FIG. 1 will now be described by referring to the flowchart shown in FIG. 2.

First, at step 201, the key word input processing section 110 of the document retrieval device 100 inputs a key word for retrieval and a retrieval request from the outside such as an application. At step 202, the time serial related word development processing section 120 searches the time serial related word dictionary 130 for relation origin words that coincide with the key word, which has been input by the key word input processing section 110, extracts related words and terms of validity associated with the relation origin words that coincide with the key word, and develops them on the memory as a list of related words of the input key word accompanied by information of the terms of validity.

At step 203, the retrieval processing section 140 retrieves documents that contain the related words developed at the step 202 from the full text retrieval database 150, and develops creation dates of documents that contain the related words and the retrieved related words on the memory as a list.

At step 204, the retrieval result selection processing section 160 sets a loop counter equal to the number of documents that have been hit in the retrieval. The processing proceeds to step 205. At step 205, it is determined whether the creation date of each of the documents retrieved at the step 203 is within the term of validity of the related word extracted at the step 202. If the creation date of the document is within the term of validity of the related word, then the processing proceeds to step 206. At step 206, the retrieval result holding processing section 170 adds a document identifier for uniquely identifying the document to the list and holds the list in the memory as a retrieval result. If the creation date of the document is not within the term of validity of the related word, then the processing returns to the step 205 and similar processing is conducted for the next document.

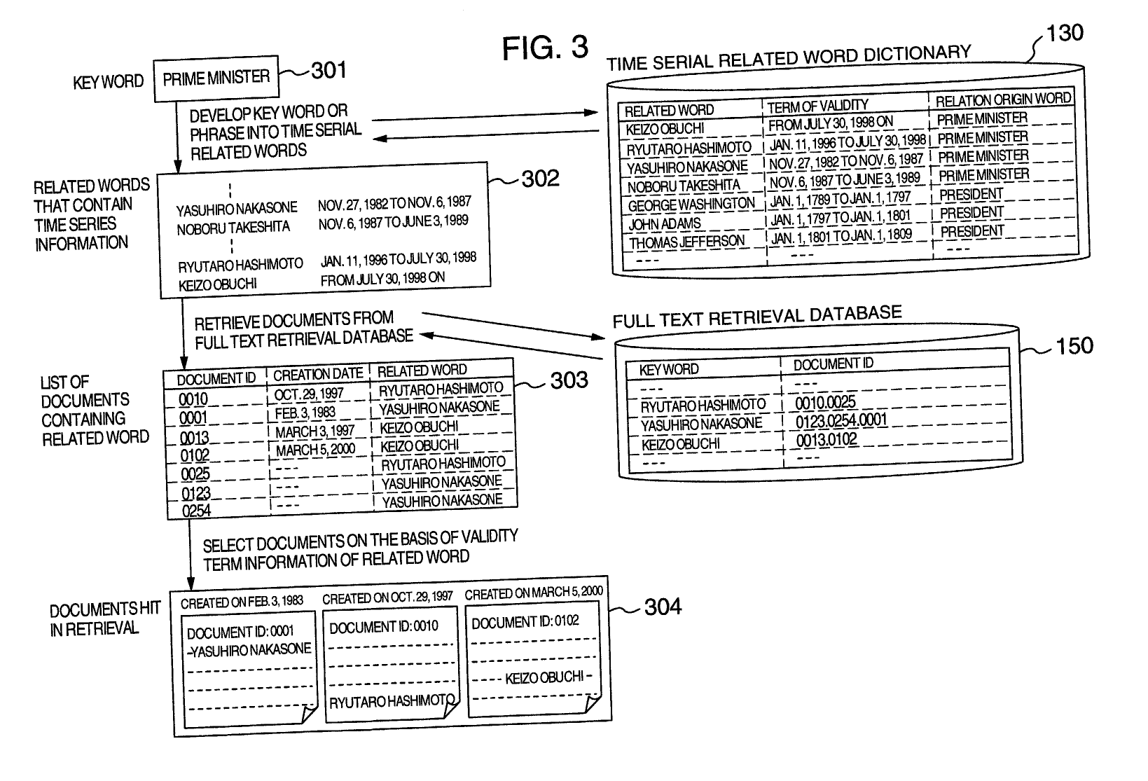

FIG. 3 is a diagram showing a concrete example of retrieval processing. Actual processing contents will now be described by using a concrete example as shown in FIG. 3. For example, it is now assumed that retrieval is conducted by using the phrase “prime minister” as the key word.

First, the key word input processing section 110 inputs “prime minister” as a key word 301. The time serial related word development processing section 120 extracts related words and terms of validity by using the time serial related word dictionary 130, and develops them on the memory as a list 302. For the “prime minister” serving as a key word, the time serial related word dictionary 130 holds “names of successive prime ministers” as related words and “terms of office” as the terms of validity. Besides, for “president” serving as a key word, the time serial related word dictionary 130 holds “names of successive U.S. presidents” as related words and “terms of office” as the terms of validity. Here, the key phrase “prime minister” is developed as a list 302 of “names of successive prime ministers” and “terms of office.” The retrieval processing section 140 retrieves documents that contain the related words included in the list 302, by using the full text retrieval database 150. At this time, creation dates and related words that have become subjects are developed on the memory as a list. Here, as results of retrieval conducted in the full text retrieval data base 150, the document 0010, the document 0001, the document 0013, the document 0102, the document 0025, the document 0123, and the document 0254 are developed as the list 303. As for the document 0010, it was created on Oct. 29, 1997 and its related word of subject is “Ryutaro Hashimoto.”

The retrieval result selection processing section 160 determines whether the creation date of each of the documents developed in the list 303 satisfies the term of validity of the related word acquired by the list 302. Upon satisfaction, the retrieval result selection processing section 160 adds the document to the retrieval result 304. Otherwise, the retrieval result selection processing section 160 does not add the document to the retrieval result 304. Since the creation date “Oct. 29, 1997” of the document 0010 is included in a term of validity “Jan. 11, 1996 to Jul. 30, 1998” of the related word “Ryutaro Hashimoto,” the document 0010 is added to the retrieval result 304. Since a creation date “Mar. 3, 1997” of the document 0013 is not included in a term of validity “from Jul. 30, 1998 on” of the related word “Keizo Obuchi,” the document 0013 is not added to the retrieval result 304. The retrieval result 304 thus obtained is held by the retrieval result holding processing section 170.

In the conventional method, a key word that changes in meaning with time is also developed into fixed related words and then retrieval is conducted. Therefore, documents different from those intended by the user are also included in the retrieval result. It takes a long time for the user to determine whether each of the documents is a desired document. In the present embodiment, however, a difference in meaning of the key word with time elapse is taken into consideration, and documents that include the developed related words and that satisfy the terms of validity are retrieved. At the time of retrieval of the related words, therefore, retrieval of documents that are not intended by the user is reduced. It thus becomes possible to improve the efficiency of the retrieval work.

In this document retrieval device, retrieval of the related words relating to a key word is conducted with respect to documents that include the related words and that satisfy the terms of validity, as heretofore described. Therefore, it is possible to retrieve suitable related words that meet the user's intention and improve the efficiency of the document retrieval work.

There will now be described a document retrieval device that conducts retrieval of related words relating to a key word by using retrieval indexes in their terms of validity.

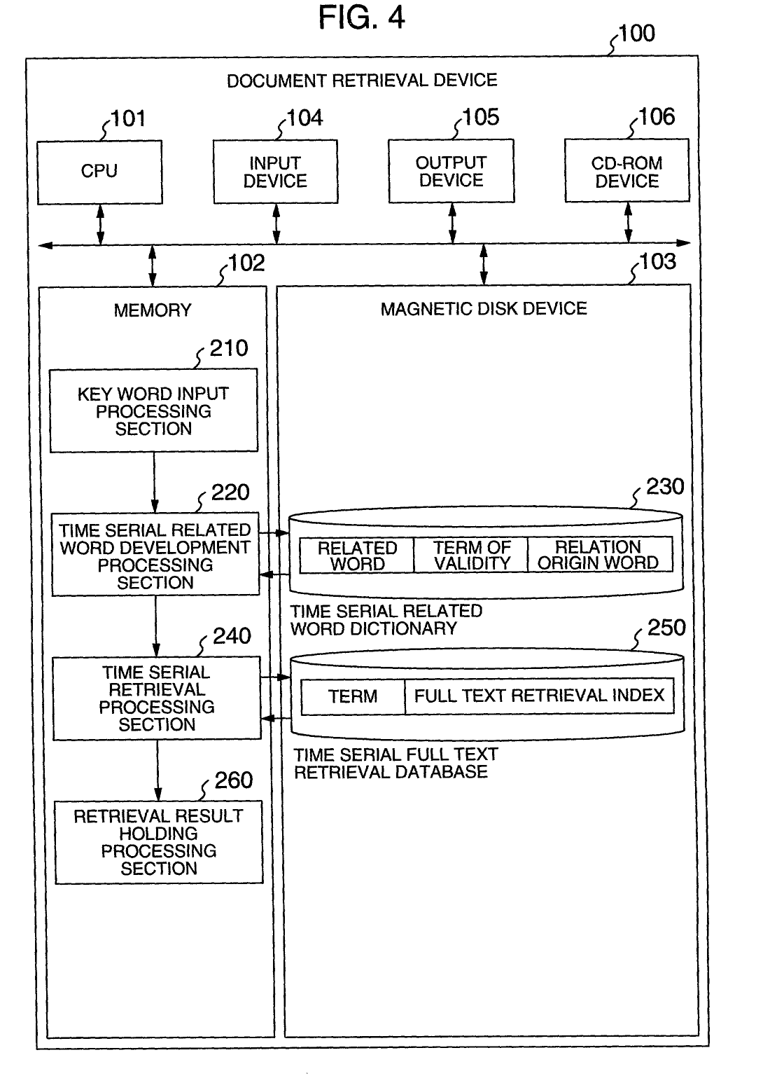

FIG. 4 is a diagram showing a schematic configuration of a document retrieval device 100. As shown in FIG. 4, the document retrieval device 100 includes a time serial related word dictionary 230 and a time serial full text retrieval database 250.

The time serial related word dictionary 230 is a dictionary that holds related words for an arbitrary key word and terms of validity of the related words. The time serial related word dictionary 230 holds data by handling a related word, a term of validity, and a relation origin word as one set. The time serial full text retrieval database 250 is a database that holds documents containing arbitrary key words or its related words, combined with all of full text retrieval indexes to a unit term and the documents made within the term, which is a database handling full text retrieval indexes per a unit term to retrieve the text.

The document retrieval device 100 further includes a key word input processing section 210, a time serial related word development processing section 220, a time serial retrieval processing section 240, and a retrieval result holding processing section 260.

The key word input processing section 210 is a processing section that receives a key word for retrieval and a retrieval request from the outside such as an application. The time serial related word development processing section 220 is a processing section for extracting related words relating to a key word, which is input by the key word input processing section 210, and terms of validity of the related words from the time serial related word dictionary 230.

The time serial retrieval processing section 240 is a processing section for retrieving documents by using the extracted related words as retrieval words, and using retrieval indexes of the related words in the terms of validity, included in the retrieval indexes of every unit term stored in the time serial full text retrieval database 250. The retrieval result holding processing section 260 is a processing section for holding the documents obtained by the retrieval conducted in the time serial retrieval processing section 240.

A program for making the document retrieval device 100 function as the key word input processing section 210, the time serial related word development processing section 220, the time serial retrieval processing section 240, and the retrieval result holding processing section 260 is recorded on a storage medium such as a CD-ROM, stored on a magnetic disk or the like, and thereafter loaded into a memory and executed. The storage medium for recording the program thereon may also be a storage medium other than the CD-ROM.

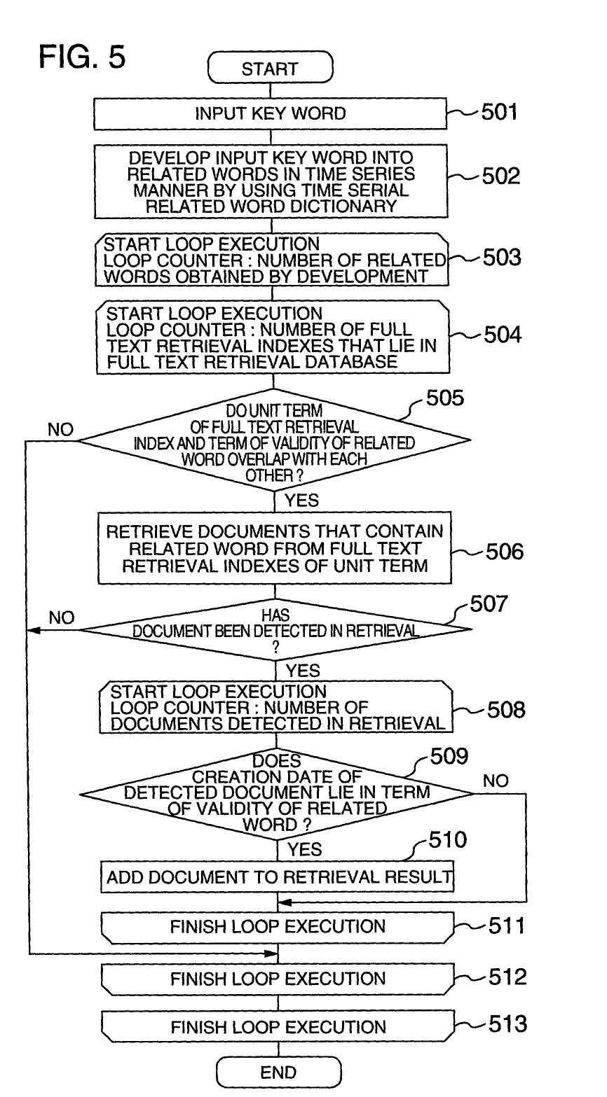

FIG. 5 is a flowchart showing a processing procedure of retrieval processing. Processing of the device having the configuration of FIG. 4 will now be described by referring to the flowchart shown in FIG. 5.

First, at step 501, the key word input processing section 210 of the document retrieval device 100 inputs a key word for retrieval and a retrieval request from the outside such as an application. At step 502, the time serial related word development processing section 220 searches the time serial related word dictionary 230 for relation origin words that coincide with the key word, which has been input by the key word input processing section 210, extracts related words and terms of validity associated with the relation origin words that coincide with the key word, and develops them on the memory as a list of related words of the input key word accompanied by information of the terms of validity.

At step 503, the time serial retrieval processing section 240 sets a loop counter equal to the number of the related words developed at the step 502. The processing proceeds to step 504. At the step 504, the time serial retrieval processing section 240 sets a loop counter equal to the number of full text retrieval indexes that exist in the time serial full text retrieval database 250. The processing proceeds to step 505.

At step 505, the unit term of a full text retrieval index is compared with the term of validity of a related word. If they overlap with each other, then the processing proceeds to step 506. At the step 506, retrieval of the related word is conducted by using the full text retrieval index. At step 507, it is determined whether documents have been retrieved as a result of the retrieval conducted at the step 506. If documents have been retrieved, then the processing proceeds to step 508.

At step 508, a loop counter is set equal to the number of documents which have been retrieved. The processing proceeds to step 509. At step 509, it is determined whether the creation date of each of the retrieved documents is within the term of validity of the related word. If the creation date of the document is within the term of validity of the related word, then the processing proceeds to step 510. At step 510, the retrieval result holding processing section 260 adds a document identifier for uniquely identifying the document to the list and holds the list in the memory as a retrieval result.

If it is determined whether the creation date of the document is within the term of validity of the related word and consequently the creation date of the document is not within the term of validity of the related word, then it is determined whether the creation date of the next document is within the term of validity of the related word. If the unit term of a full text retrieval index is compared with a term of validity of a related word at the step 505 and consequently they do not overlap with each other, then comparison is conducted with respect to the term of validity of the next full text retrieval index. If comparison of the unit terms of all full text retrieval indexes with the term of validity of the related word has been finished, then the unit term of a full text retrieval index is compared with a term of validity of the next related word.

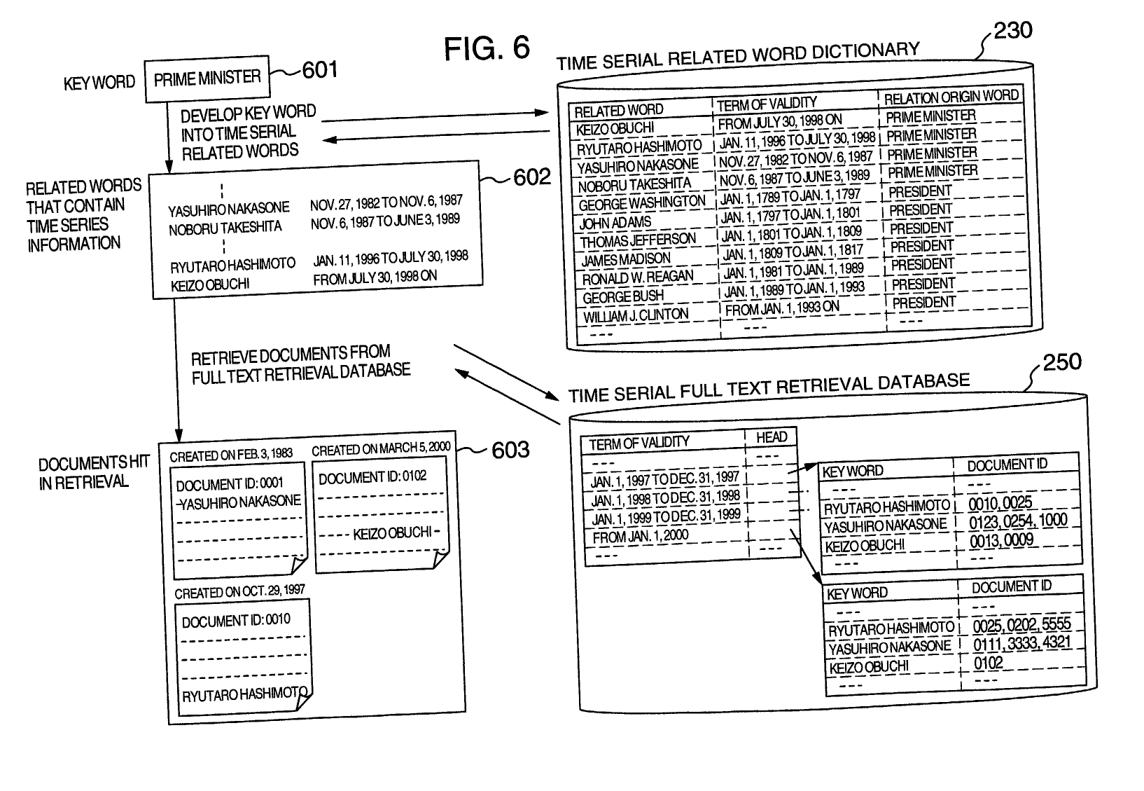

FIG. 6 is a diagram showing a concrete example of retrieval processing of the present embodiment. Actual processing contents will now be described by using a concrete example as shown in FIG. 6. For example, it is now assumed that retrieval is conducted by using the phrase “prime minister” as the key word.

First, the key word input processing section 210 inputs “prime minister” as a key word 601. The time serial related word development processing section 220 extracts related words and terms of validity by using the time serial related word dictionary 230, and develops them on the memory as a list 602. For the “prime minister” serving as a key word, the time serial related word dictionary 230 holds “names of successive prime ministers” as related words and “terms of office” as the terms of validity. Besides, for “president” serving as a key word, the time serial related word dictionary 230 holds “names of successive U.S. presidents” as related words and “terms of office” as the terms of validity. Here, the “prime minister” serving as the key word is developed as a list 602 of “names of successive prime ministers” and “terms of office.”

The time serial retrieval processing section 240 retrieves documents by using the full text retrieval database 250 on the basis of the list 602. For example, the term of validity of “Keizo Obuchi” serving as the related word is “on and after Jul. 30, 1998.” Therefore, there is conducted retrieval of the full text retrieval indexes of terms “Jul. 30, 1998 to Dec. 31, 1998,” “Jan. 1, 1999 to Dec. 31, 1999,” and “on and after Jan. 1, 2000” in the time serial full text retrieval database 250. A document 0102 that includes “Keizo Obuchi” exists in full text retrieval indexes of “on and after Jan. 1, 2000.” In addition, the creation date of the document 0102 is “Mar. 5, 2000.” The creation date conforms to “on and after Jul. 30, 1998,” which is the term of validity of the related word “Keizo Obuchi.” Therefore, the document 0102 is judged to be a desired document, and it is added to a retrieval result 603. Documents 0013 and 0009 that include “Keizo Obuchi” serving as the key word exist in full text retrieval indexes of “Jan. 1, 1997 to Dec. 31, 1997.” Since they do not conform to “on and after Jul. 30, 1998,” which is the term of validity of the related word “Keizo Obuchi,” however, they are not included in the retrieval result 603.

Similar processing is conducted with respect to each of the related words developed on the list 602. The retrieval result 603 thus obtained is held by the retrieval result holding processing section 260.

According to the present embodiment, the full text retrieval indexes of the time serial full text retrieval data base 250 is divided into unit terms. Therefore, it is not necessary to conduct retrieval on all documents stored in the database. In addition, the amount of the documents retrieved from the full text retrieval indexes is restricted as compared with the amount of documents retrieved from all of the full text retrieval indexes. Accordingly, the number of times of checking the creation dates of documents and terms of validity of related words is reduced. As a result, it can be said that efficient retrieval can be conducted.

According to the document retrieval device of the present embodiment, retrieval of related words relating to a key word is conducted by using retrieval indexes that satisfy their terms of validity as heretofore described. As a result, it is possible to increase the speed of retrieval of related words that satisfy the terms of validity.

There will now be described a document retrieval device that acquires terms of validity of related words from a related word validity term database, and selects documents containing related words and satisfying the terms of validity on the basis of a result of retrieval of related words relating to a key word.

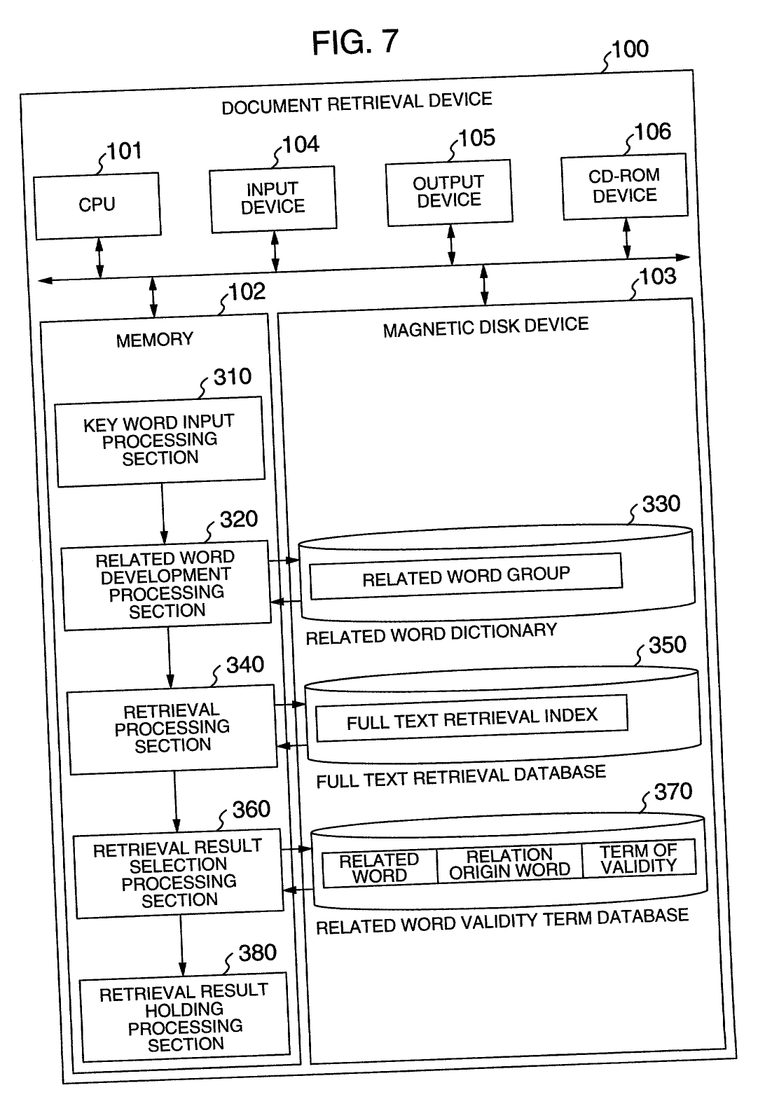

FIG. 7 is a diagram showing a schematic configuration of a document retrieval device 100. As shown in FIG. 7, the document retrieval device 100 of the present embodiment includes a related word dictionary 330, a full text retrieval database 350, and a related word validity term database 370.

The related word dictionary 330 is a dictionary that administers a set of related words used to develop an arbitrary key word into related words. The full text retrieval database 350 is a database that holds documents containing an arbitrary key word or its related words, and full text retrieval indexes for retrieving the documents.

The related word validity term database 370 is a database that administers relations among a key word, related words, and terms of validity in order to make it possible to acquire terms of validity of related words from an arbitrary key word. The related word validity term database 370 holds data by handling a related word, a term of validity, and a relation origin word as one set.

The document retrieval device 100 further includes a key word input processing section 310, a related word development processing section 320, a retrieval processing section 340, a retrieval result selection processing section 360, and a retrieval result holding processing section 380.

The key word input processing section 310 is a processing section that receives a key word for retrieval and a retrieval request from the outside such as an application. The related word development processing section 320 is a processing section for extracting related words relating to a key word, which is input by the key word input processing section 310.

The retrieval processing section 340 is a processing section for retrieving documents stored in the full text retrieval database 350, by using the extracted related words as retrieval words. The retrieval result selection processing section 360 is a processing section for acquiring terms of validity of related words extracted by the related word development processing section 320 from the related word validity term database 370, collating creation dates of the documents retrieved by the retrieval processing section 340 with the terms of validity of the related words, and selecting documents within the acquired terms of validity from the retrieved documents. The retrieval result holding processing section 380 is a processing section for holding the documents obtained by the selection conducted in the retrieval result selection processing section 360, as a retrieval result. A program for making the document retrieval device 100 function as the key word input processing section 310, the related word development processing section 320, the retrieval processing section 340, the retrieval result selection processing section 360, and the retrieval result holding processing section 380 is recorded on a storage medium such as a CD-ROM, stored on a magnetic disk or the like, and thereafter loaded into a memory and executed. The storage medium for recording the program thereon may also be a storage medium other than the CD-ROM.

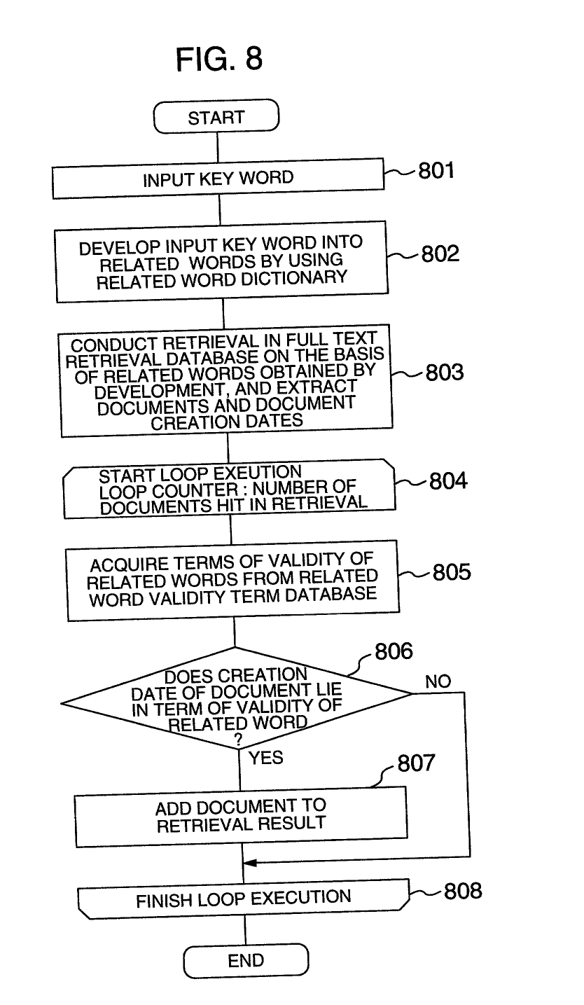

FIG. 8 is a flowchart showing a processing procedure of retrieval processing. Processing of the device having the configuration of FIG. 7 will now be described by referring to the flowchart shown in FIG. 8.

First, at step 801, the key word input processing section 310 of the document retrieval device 100 inputs a key word for retrieval and a retrieval request from the outside such as an application. At step 802, the related word development processing section 320 extracts related words that relate to the key word, which has been input by the key word input processing section 310, by referring to the related word dictionary 330, and develops them on the memory as a list of related words of the input key word.

At step 803, the retrieval processing section 340 retrieves documents that contain the related words developed at the step 802 from the full text retrieval database 350, and acquires related words of hit subject and creation dates of documents.

At step 804, the retrieval result selection processing section 360 sets a loop counter equal to the number of documents hit in the retrieval of the step 803. The processing proceeds to step 805. At the step 805, terms of validity of related words subjected to retrieval are acquired from the related word validity term database 370.

At step 806, the creation date of the document is compared with the acquired term of validity of its related word. If the creation date of the document is within the term of validity of its related word, then the processing proceeds to step 807. Otherwise, it is determined whether a creation date of the next document is within the term of validity of its related word. At the step 807, the retrieval result holding processing section 380 adds a document identifier for uniquely identifying the document to the list and holds the list in the memory as a retrieval result.

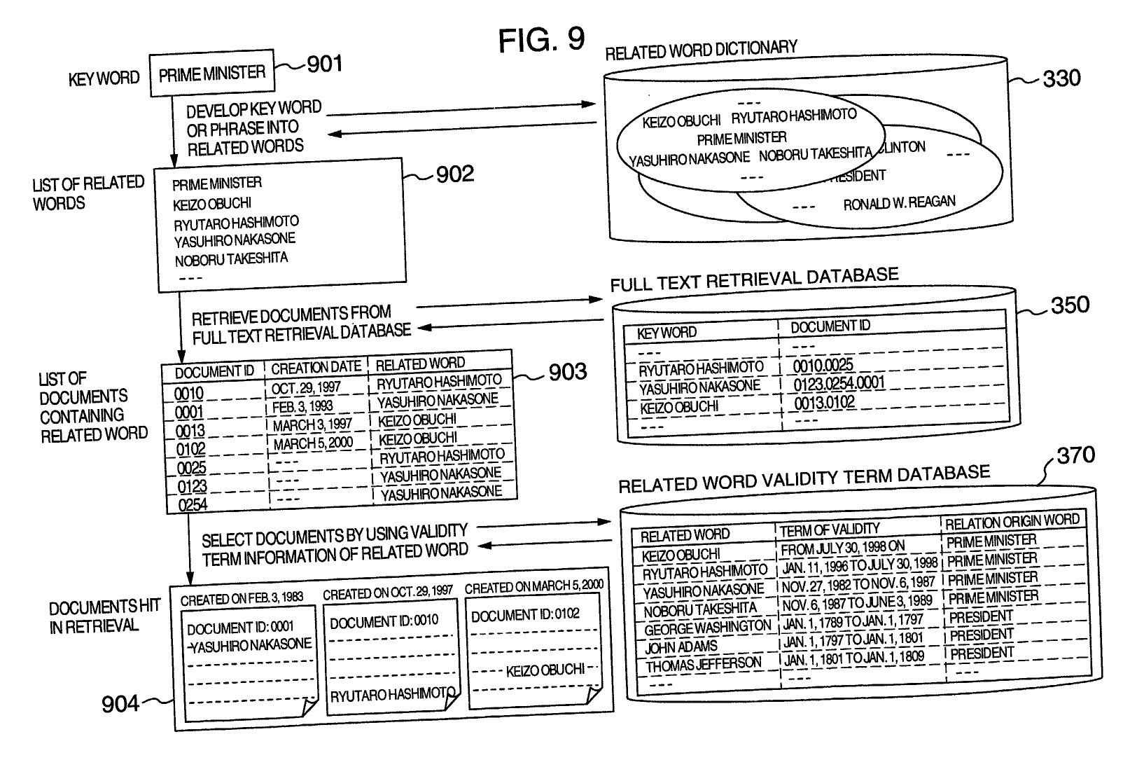

FIG. 9 is a diagram showing a concrete example of retrieval processing. Actual processing contents will now be described by using a concrete example as shown in FIG. 9. For example, it is now assumed that retrieval is conducted by using the phrase “prime minister” as the key word.

First, the key word input processing section 310 inputs “prime minister” as a key word 901. The related word development processing section 320 develops a list 902 of related words of a related word group that contains “prime minister” serving as a key word, by using the related word dictionary 330. Here, the “prime minister” serving as the key word is developed into “names of successive prime ministers.” The retrieval processing section 340 retrieves documents by using the full text retrieval database 350 on the basis of the list 902, and develops IDs, subject related words, and creation dates of hit documents on the memory as a list 903.

With respect to each of the documents included in the list 903, the retrieval result selection processing section 360 acquires a term of validity of the related word from the related word validity term database 370, and compares the acquired term of validity with the creation date of the document. For example, as for a document 0010, the term of validity of “Ryutaro Hashimoto” serving as the related word acquired from the related word validity term database 370 is “Jan. 11, 1996 to Jul. 30, 1998,” and the creation date “Oct. 29, 1997” of the document is within the term of validity. Therefore, the document 0010 is added to a retrieval result 904. As for a document 0013, the term of validity of the related word “Keizo Obuchi” acquired from the related word validity term database 370 is “from Jul. 30, 1998 on.” The creation date “Mar. 3, 1997” of the document 0013 is not within the term of validity, and consequently the document 0013 is not included in the retrieval result 904. Similar processing is conducted with respect to each of the documents developed on the list 903. The retrieval result 904 thus obtained is held by the retrieval result holding processing section 380.

In the document retrieval device 100 of the present embodiment, an existing configuration can be used as its former half ranging to the retrieval processing section 340. By adding the retrieval result selection processing section 360 and the related word validity term database 370 to the configuration, the document retrieval device 100 of the present embodiment can be implemented. Therefore, it can be said that the present embodiment is an embodiment that facilitates function expansion to the existing configuration.

According to the document retrieval device of the present embodiment, terms of validity of related words are acquired from the related words validity term database, and documents containing related words and satisfying the terms of validity are selected on the basis of a result of retrieval of related words relating to a key word, as heretofore described. Therefore, it is possible to expand an existing system to such a configuration as to conduct retrieval on the related words satisfying the terms of validity, without conducting a remarkable alteration.

According to the present invention, retrieval of the related words relating to a key word is conducted with respect to documents that include the related words and that satisfy the terms of validity. Therefore, it is possible to retrieve suitable related words that meet the user's intention and improve the efficiency of the document retrieval work.

What is claimed is:

1. A document retrieval method for retrieving desired documents from a document database by using a key word, comprising:
extracting related words relating to an input key word and terms of validity of the related words;
retrieving documents by using the extracted related words as retrieval words; and
selecting documents in the extracted terms of validity from among the retrieved documents.

2. A document retrieval method for retrieving desired documents from a document database by using a key word, comprising:
extracting related words relating to an input key word and terms of validity of the related words; and
retrieving documents by using the extracted related words as retrieval words and using retrieval indexes of the related words that satisfy the terms of validity, included in the retrieval indexes of every unit term.

3. A document retrieval method for retrieving desired documents from a document database by using a key word, comprising:
extracting related words relating to an input key word;
retrieving documents by using the extracted related words as retrieval words; and
acquiring terms of validity of the related words relating to the input key word, and selecting documents that satisfy the acquired terms of validity from among the retrieved documents.

4. A document retrieval device for retrieving desired documents from a document database by using a key word, comprising:
a time serial related word development processing section for extracting related words relating to an input key word and terms of validity of the related words;
a retrieval processing section for retrieving documents by using the extracted related words as retrieval words; and
a retrieval result selection processing section for selecting documents that satisfy the extracted terms of validity from the retrieved documents.

5. A computer-readable storage medium having a program recorded thereon, the program making a computer function as a document retrieval device for retrieving desired documents from a document database by using a key word, comprising:
extracting related words relating to an input key word and terms of validity of the related words;
retrieving documents by using the extracted related words as retrieval words; and
selecting documents that satisfy the extracted terms of validity from among the retrieved documents.

6. A document retrieval program for retrieving desired documents from a document database by using a key word, comprising:
extracting related words relating to an input key word and terms of validity of the related words;
retrieving documents by using the extracted related words as retrieval words; and
selecting documents that satisfy the extracted terms of validity from the retrieved documents.
